(19) United States
(12) Patent Application Publication
(10) Pub. No.: US 2010/0130202 A1
(43) Pub. Date: May 27, 2010

(54) METHOD AND USER EQUIPMENT FOR MEASURING CELLS AND READING CONTROL CHANNELS

(75) Inventor: Yinghui Yu, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: HUAWEI TECHNOLOGIES CO., LTD., Shenzhen (CN)

(21) Appl. No.: 12/697,568

(22) Filed: Feb. 1, 2010

Related U.S. Application Data
(63) Continuation of application No. PCT/CN2008/071988, filed on Aug. 14, 2008.

(30) Foreign Application Priority Data
Aug. 17, 2007 (CN) 200710146737.4
May 4, 2008 (CN) 200810094715.2

(51) Int. Cl. H04W 24/00

(52) U.S. Cl. 455/434

(57) ABSTRACT

A method for measuring cells includes: scanning a frequency point; judging whether the signal level of the scanned frequency point meets a pre-configured measurement condition; if the signal level of the scanned frequency point meets the pre-configured measurement condition, identifying a cell corresponding to the frequency point, and measuring the signal level of the cell. With the technical solution of the invention, the number of cells measured by the UE may be limited, which prevents the UE from measuring too many cells.

### CROSS-REFERENCE TO RELATED APPLICATIONS

This application is a continuation of International Application No. PCT/CN2008/071988, filed on Aug. 14, 2008, which claims priority to Chinese Patent Application No. 200710146737.4, filed on Aug. 14, 2007 and Chinese Patent Application No. 200810094715.2, filed on May 4, 2008, all of which are hereby incorporated by reference in their entireties.

### FIELD OF THE INVENTION

The present invention relates to a communication technology, and in particular, to a method and user equipment (UE) for measuring cells and reading control channels.

### BACKGROUND OF THE INVENTION

When a UE is residing in a network, the UE monitors neighbor cells continuously, and identifies and measures the monitored neighbor cells. The UE may also read the offsets of the identified cells through control channels, for example, a broadcast control channel and a multimedia broadcast multicast service (MBMS) control channel. The UE sorts the identified cells according to the measurement results and offsets of the neighbor cells, and uses the top cell as the reselected cell. The measurement results may include measurement strength, measurement quality, and interference strength. The offsets of the cells include: cell individual offset, one-to-one offset between cells and offset of the MBMS preferred frequency layer. The cell individual offset is the offset between one cell and the rest of cells. The one-to-one offset between cells is a special offset configured between two cells. The one-to-one offset between a same serving cell and its neighbor cells may vary. The offset of the MBMS preferred frequency layer is a one-to-many offset between one frequency layer and other frequency layers.

### SUMMARY OF THE INVENTION

Embodiments of the present invention provide a method and UE for measuring cells and reading control channels.

A method for measuring cells in an embodiment of the present invention includes:

scanning a frequency point; and

judging whether the scanned frequency point meets a pre-configured measurement condition; if the scanned frequency point meets the pre-configured measurement condition, identifying a cell corresponding to the frequency point, and measuring the signal level of the cell.

A method for reading control channels in an embodiment of the present invention includes:

judging whether a cell meets a pre-configured read condition; if the cell meets the pre-configured read condition, reading control channel information of the cell.

A method for measuring cells and reading control channels in an embodiment of the present invention includes:

scanning a frequency point;

judging whether the scanned frequency point meets a pre-configured measurement condition; if the scanned frequency point meets the pre-configured measurement condition, identifying a cell corresponding to the frequency point, and measuring the signal level of the cell; and

judging whether the cell meets a pre-configured read condition; if the cell meets the pre-configured read condition, reading control channel information of the cell.

A method for identifying cells in an embodiment of the present invention includes:

by a UE, reading control channel information of a cell, where the information includes an upper-layer ID of the cell; and

judging whether the read upper-layer ID of the cell is the upper-layer ID in a neighbor cell list (NCL); if the read upper-layer ID of the cell is the upper-layer ID in the NCL, determining that the cell can be identified by the UE, where the NCL is obtained from the serving cell of the UE.

A UE provided in an embodiment of the present invention includes:

a scanning unit, adapted to scan a frequency point;

a frequency point judging unit, adapted to judge whether the scanned frequency point meets a pre-configured measurement condition;

an identifying unit, adapted to identify a cell corresponding to the frequency point when the judgment result of the frequency point judging unit is positive; and

a measuring unit, adapted to measure the signal level of the identified cell.

A UE provided in an embodiment of the present invention includes:

a cell judging unit, adapted to judge whether a cell meets a pre-configured read condition; and

a control channel reading unit, adapted to read control channel information of the cell when the judgment result of the cell judging unit is positive.

A UE provided in an embodiment of the present invention includes:

a control channel reading unit, adapted to read control channel information of a cell, where the read information includes the upper-layer ID of the cell;

a judging unit, adapted to judge whether the read upper-layer ID of the cell is the upper-layer ID in an NCL, where the NCL is obtained from the serving cell of the UE; and

a determining unit, adapted to determine that the cell can be identified by the UE when the judgment result of the judging unit is positive.

It can be seen from the above description that, one of the preceding method and UE provided in embodiments of the present invention can prevent the UE from measuring too many cells and thus save system resources.

### BRIEF DESCRIPTION OF THE DRAWINGS

FIG. 1 is a flowchart of a method for measuring cells in a first embodiment of the present invention;

FIG. 2 is a flowchart of a method for measuring cells in a second embodiment of the present invention;

FIG. 3 is a flowchart of a method for reading control channels in a third embodiment of the present invention;

FIG. 4 is a flowchart of a method for reading control channels in a fourth embodiment of the present invention;

FIG. 5 is a flowchart of a method for measuring cells and reading control channels in a fifth embodiment of the present invention;

FIG. 6 is a flowchart of a method for measuring cells and reading control channels in a sixth embodiment of the present invention;

FIG. 7 is a flowchart of a method for measuring cells and reading control channels in a seventh embodiment of the present invention;

FIG. 8 is a flowchart of a method for reading control channels in an eighth embodiment of the present invention;

FIG. 9 is a flowchart of a method for reading control channels in a ninth embodiment of the present invention;

FIG. 10 is a flowchart of a method for reading control channels in a tenth embodiment of the present invention;

FIG. 11 shows a structure of a UE in an eleventh embodiment of the present invention;

FIG. 12 shows a structure of a UE in a twelfth embodiment of the present invention;

FIG. 13 shows a structure of a UE in an thirteenth embodiment of the present invention; and

FIG. 14 shows a structure of a UE in a fourteenth embodiment of the present invention.

### DETAILED DESCRIPTION OF THE EMBODIMENTS

A first embodiment and a second embodiment of the present invention provide a method for measuring cells. The method includes: scanning a frequency point; judging whether the scanned frequency point meets a pre-configured measurement condition; if the scanned frequency point meets the pre-configured measurement condition, identifying a cell corresponding to the frequency point, and measuring the signal level of the cell. With the technical solution provided in the embodiments, the number of cells measured by the UE is limited, which prevents the UE from measuring too many cells.

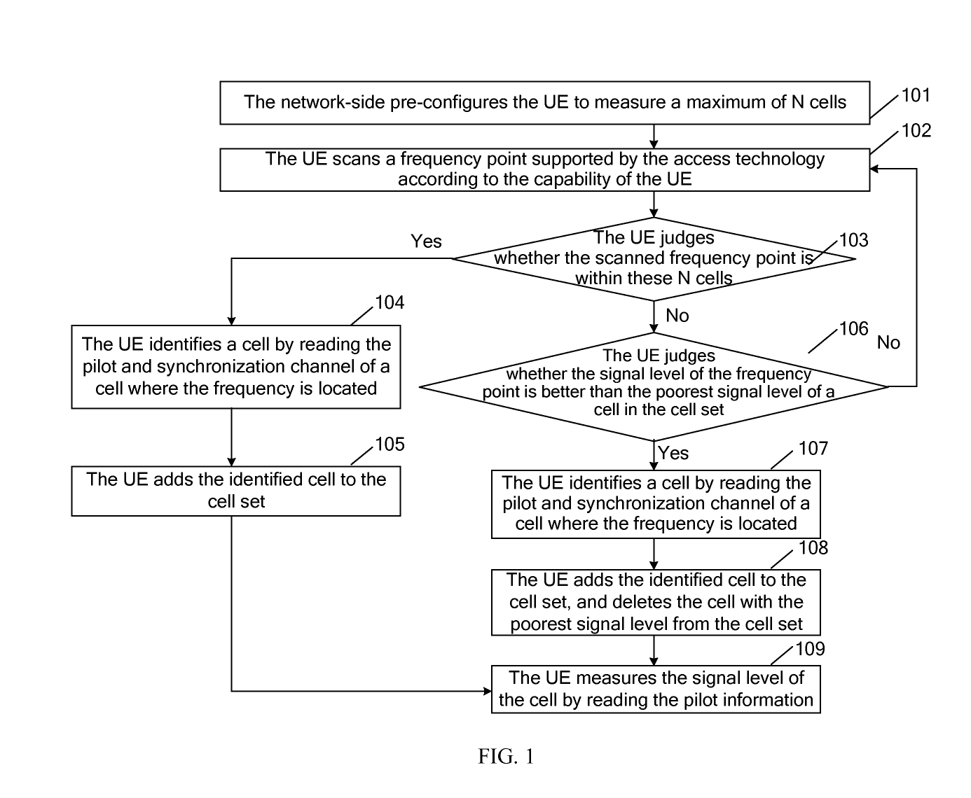

FIG. 1 is a flowchart of a method for measuring cells in a first embodiment of the present invention. The method includes:

Step 101: The network pre-configures the UE to measure a maximum of N cells.

The N cells in this step are determined by the operator according to experience, and configured in the network.

Step 102: The UE scans a frequency point supported by the access technology according to the capability of the UE.

In a network system, the protocol specifies a frequency band for operation. The UE scans a frequency point within the frequency band according to the capability of the UE.

Step 103: The UE judges whether the scanned frequency point is within these N cells; if the scanned frequency point is within these N cells, the process proceeds to step 104; otherwise, the process proceeds to step 106.

Step 104: The UE identifies a cell by reading the pilot and synchronization channel of a cell where the frequency point is located.

Step 105: The UE adds the identified cell to a cell set. Then, the process proceeds to step 109.

The cell set is a set of a pre-configured number of cells, and includes a maximum of N cells.

Before this step, the UE may also predetermine a threshold. This step of adding the identified cell to the cell set may be executed only when the signal level of the frequency point is higher than the pre-configured threshold.

Step 106: The UE judges whether the signal level of the scanned frequency point is higher than the poorest signal level of a cell in the cell set. If the signal level of the scanned frequency point is higher than the poorest signal level of a cell in the cell set, the process proceeds to step 107; otherwise, the process goes back to step 102.

The signal level may be represented by signal strength, signal quality or interference strength. The greater the signal strength is, the higher the signal level will be; or the better the signal quality is, the higher the signal level will be; or the less interference strength is, the higher the signal level will be. The process proceeds to step 107 when the signal strength of the scanned frequency point is greater than the littlest signal strength of a cell in the cell set, or when the signal quality of the scanned frequency point is better than the poorest signal quality of a cell in the cell set, or when the interference strength of the scanned frequency point is less than the littlest interface strength of a cell in the cell set.

Step 107: The UE identifies a cell by reading the pilot and synchronization channel of a cell where the frequency point is located.

Step 108: The UE adds the identified cell in step 107 to the cell set, and deletes the cell with the poorest signal level from the cell set.

Step 109: The UE measures the signal level of the cell by reading the pilot information.

In the foregoing embodiment of the present invention, the UE may not need to judge whether the scanned frequency point is within the N frequency points, which does not affect the implementation of the present invention. For example, a time segment may be pre-configured; when the time segment expires, the UE does not judge whether the scanned frequency point is within the N frequency points; instead, the UE judges whether the signal level of the scanned frequency point is higher than the lowest signal level of a cell in the cell set.

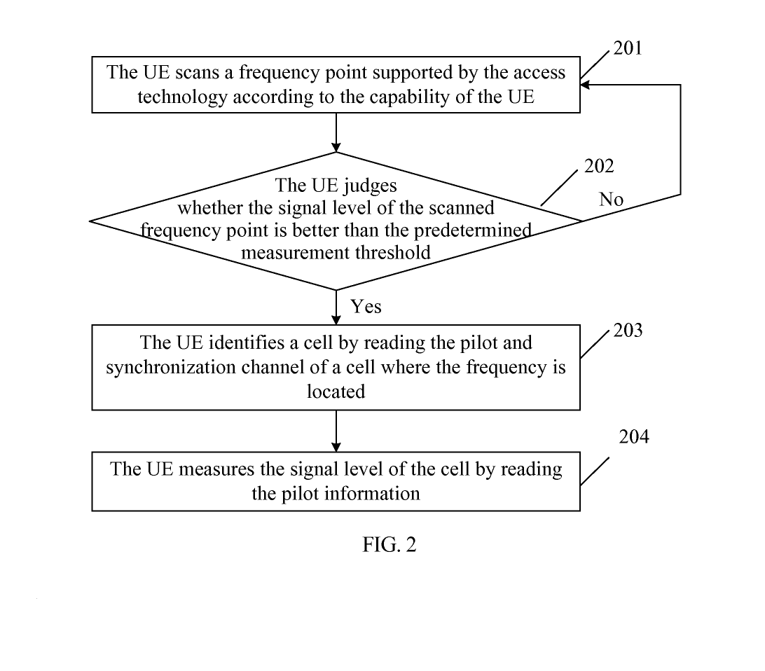

FIG. 2 is a flowchart of a method for measuring cells in a second embodiment of the present invention. The method includes:

Step 201: The UE scans a frequency point supported by the access technology according to the capability of the UE.

Step 202: The UE judges whether the signal level of the scanned frequency point is higher than a pre-configured measurement threshold. If the signal level of the scanned frequency point is higher than the pre-configured measurement threshold, the process proceeds to step 203; otherwise, the process goes back to step 201.

If the signal level of the scanned frequency point is not higher than the pre-configured measurement threshold, the process goes back to step 201; that is, the UE continues to scan other frequency points.

When the signal level is represented by the signal strength, the UE judges whether the signal strength of the scanned frequency point is greater than the pre-configured signal strength threshold; if the signal strength of the scanned frequency point is greater than the pre-configured signal strength threshold, the process proceeds to step 203. When the signal level is represented by the signal quality, the UE judges whether the signal quality of the scanned frequency point is better than the pre-configured signal quality threshold; if the signal quality of the scanned frequency point is better than the pre-configured signal quality threshold, the process proceeds to step 203. When the signal level is represented by the interference strength, the UE judges whether the interference strength of the scanned frequency point is less than the pre-configured interference strength threshold; if the interference strength of the scanned frequency point is less than the pre-configured interference strength threshold, the process proceeds to step 203.

Step 203: The UE identifies a cell by reading the pilot and synchronization channel of a cell where the frequency point is located.

Step 204: The UE measures the signal level of the cell by reading the pilot information.

In this embodiment of the present invention, when the UE determines that the signal levels of all scanned frequency points do not reach the pre-configured measurement threshold, the UE changes the pre-configured measurement threshold, reduces the signal strength threshold and signal quality threshold, and increases the interference strength threshold. Then, the process goes back to step 202.

In this embodiment, the UE judges whether the signal level of the scanned frequency point meets the pre-configured measurement condition. The UE measures the signal level of the cell corresponding to the frequency point only when the signal level of the scanned frequency point meets the pre-configured measurement condition. Thus, the number of cells measured by the UE is limited, which prevents the UE from measuring too many cells.

A method for reading control channels in an embodiment of the present invention includes: judging whether a cell meets a pre-configured read condition; if the cell meets the pre-configured read condition, reading the control channel information of the cell. With the technical solution provided in this embodiment of the present invention, the number of cells read by the UE is limited.

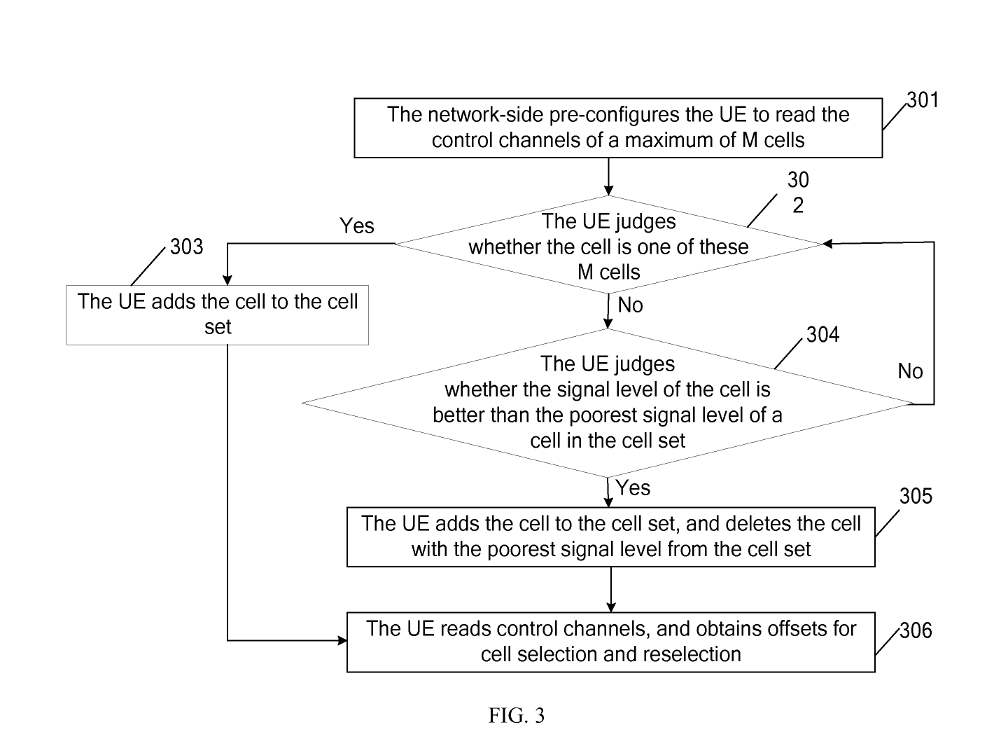

FIG. 3 is a flowchart of a method for reading control channels in a third embodiment of the present invention. The method includes:

Step 301: The network-side pre-configures the UE to read control channels of M cells at most.

Step 302: The UE judges whether a cell is within the M cells; if the cell is within the M cells, the process proceeds to step 303; otherwise, the process proceeds to step 304.

Step 303: The UE adds the cell to the cell set. Then, the process proceeds to step 306.

In this step, the UE may also predetermine a threshold. The UE adds the cell to the cell set only when the signal level of the identified cell is higher than the pre-configured threshold so as to establish an initial cell set.

Step 304: The UE judges whether the signal level of the cell is higher than the lowest signal level of a cell in the cell set. If the signal level of the cell is higher than the lowest signal level of the cell in the cell set, the process proceeds to step 305; otherwise, the process goes back to step 302.

In this step, if the signal level of the cell is not higher than the lowest signal level of a cell in the cell set, the process goes back to step 302; that is, the UE continues to judge other cells.

The UE may judge whether the signal level of the cell is higher than the lowest signal level of a cell in the cell set in the following modes: when the signal level of the cell is represented by the signal strength of the cell, the UE judges whether the signal strength of the cell is greater than the littlest signal strength of a cell in the cell set; when the signal level of the cell is represented by the signal quality of the cell, the UE judges whether the signal quality of the cell is better than the poorest signal quality of a cell in the cell set; when the signal level of the cell is represented by the interference strength of the cell, the UE judges whether the interference strength of the cell is less than the littlest interference strength of a cell in the cell set.

Step 305: The UE adds the cell to the cell set, and deletes the cell with the lowest signal level from the cell set.

Step 306: The UE reads control channels, and obtains all the offsets for cell selection and reselection in the cell set.

The control channels in this step include a broadcast control channel (BCCH) and an MBMS point-to-multipoint control channel (MCCH). The BCCH is used by a NodeB to broadcast public information to all the UEs. The system information blocks of the public information include cell selection and reselection parameters, which include: one-to-one offset between cells and cell individual offset of a cell. The information broadcasted in the MCCH includes MBMS related control messages and an offset of the MBMS preferred frequency layer, which is a one-to-many offset between one frequency layer and other frequency layers.

The offsets of the cell in this step include: one-to-one offset between cells, cell individual offset, and offset of the MBMS preferred frequency layer.

In this step, the process of obtaining the offsets of the cell by the UE includes: judging whether a value tag that is used to indicate whether the offsets are changed in the information broadcasted in the MCCH and the BCCH of the cell indicates that the offsets is changed; if the value tag indicates that the offsets is changed, decoding the offsets in the information broadcasted in the MCCH and the BCCH, and obtaining the offsets of the cell; otherwise, using the read offsets of the cell, without decoding the offsets in the broadcasted information.

In a third embodiment of the present invention, the UE may not need to judge whether the cell is within the M cells, which does not affect the implementation of the present invention. For example, a time segment may be pre-configured; after the time segment expires, the UE does not judge whether the cell is within the M cells; instead, the UE judges whether the signal level of the cell is higher than the lowest signal level of a cell in the cell set.

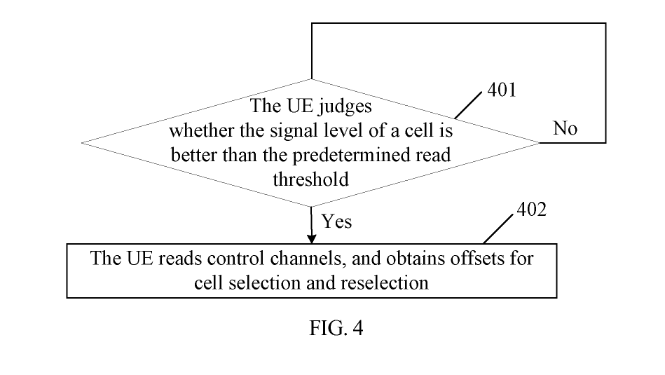

FIG. 4 is a flowchart of a method for reading control channels in a fourth embodiment of the present invention. The method includes:

Step 401: The UE judges whether the signal level of a cell is higher than a pre-configured read threshold. If the signal level of the cell is higher than the pre-configured read threshold, the process proceeds to step 402; otherwise, the process goes back to step 401 again.

In this step, if the signal level of the cell is not higher than the pre-configured read threshold, the process goes back to step 401 again; that is, the UE continues to judge whether the signal levels of other cells are higher than the pre-configured read threshold.

In this step, the UE may judge whether the signal level of the cell is higher than the pre-configured read threshold in the following modes: when the signal level of the cell is represented by the signal strength, the UE judges whether the signal strength of the cell is greater than the pre-configured signal strength threshold; when the signal level of the cell is represented by the signal quality, the UE judges whether the signal quality of the cell is better than the pre-configured signal quality threshold; when the signal level of the cell is represented by the interference strength, the UE judges whether the interference strength of the cell is less than the pre-configured interference strength threshold.

Step 402: The UE reads control channels, and obtains the offsets for cell selection and reselection.

In this step, the control channels include the BCCH and the MCCH. The BCCH is used by the NodeB to broadcast public information to all the UEs, where the public information includes offsets for cell selection and reselection: one-to-one offset between cells and cell individual offset. The information broadcasted in the MCCH includes the offset of the MBMS preferred frequency layer. The offsets of the cell in this step include: one-to-one offset between cells, cell individual offset, and offset of the MBMS preferred frequency layer.

In this step, the process of obtaining the offsets of the cell by the UE includes: judging whether a value tag that is used to indicate whether the offsets are changed in the information broadcasted in the MCCH and the BCCH of the cell indicates that the offsets are changed; if the value tag indicates that the offsets are changed, decoding the offsets in the information broadcasted in the MCCH and the BCCH, and obtaining the offsets of the cell; otherwise, using the previously read offsets of the cell, without decoding the offsets in the broadcasted information.

In a fourth embodiment of the present invention, when the UE determines that the signal levels of cells do not reach the pre-configured read threshold, the UE changes the pre-configured read threshold, reduces the signal strength threshold and signal quality threshold, and increases the interference strength threshold. Then, the process proceeds to step 402 again.

In this embodiment, the UE judges whether the signal level of the cell is higher than the pre-configured read threshold. The UE reads control channels only when the signal level of the cell is higher than the pre-configured read threshold. Thus, the number of cells read by the UE is limited; the time needed by the UE to read the control channels of the cell is reduced; and the mobility processing time of the UE is saved. In addition, the UE reads only control channels of cells whose signal levels are higher than the pre-configured read threshold, where these cells have high signal levels, so that the decoding error rate is reduced when the UE reads the control channels to obtain the parameters of the cells.

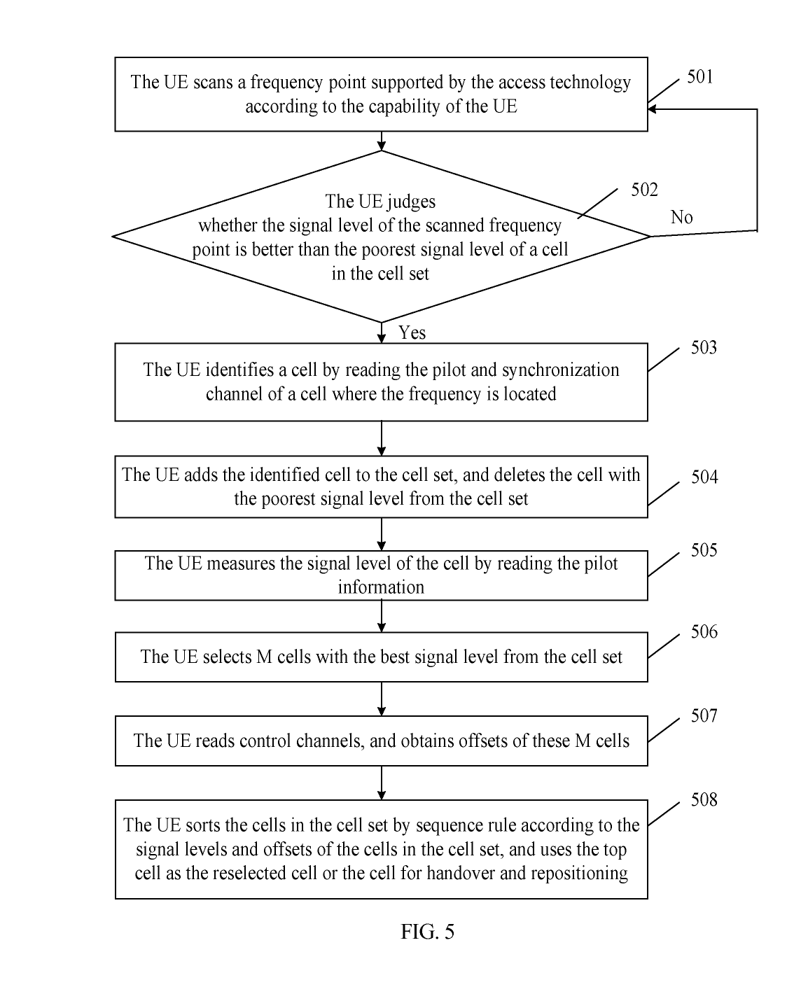

FIG. 5 is a flowchart of a method for measuring cells and reading control channels in a fifth embodiment of the present invention. The method includes:

Step 501: The UE scans a frequency point supported by the access technology according to the capability of the UE.

Step 502: The UE judges whether the signal level of the scanned frequency point is higher than the lowest signal level of a cell in the cell set. If the signal level of the scanned frequency point is higher than the lowest signal level of the cell in the cell set, the process proceeds to step 503; otherwise, the process goes back to step 501.

In this step, when the signal strength of the scanned frequency point is greater than the littlest signal strength of a cell in the cell set, the process proceeds to step 503; or when the signal quality of the scanned frequency point is better than the poorest signal quality of a cell in the cell set, the process proceeds to step 503; or when the interference strength of the scanned frequency point is less than the littlest interference strength of a cell in the cell set, the process proceeds to step 503.

Step 503: The UE identifies a cell by reading the pilot and synchronization channel of a cell where the frequency is located.

Step 504: The UE adds the identified cell in the preceding step to the cell set, and deletes the cell with the poorest signal level from the cell set.

Step 505: The UE measures the signal level of the cell by reading the pilot information.

Step 506: The UE selects M cells with the best signal level in the cell set.

Step 507: The UE reads control channels and obtains offsets of these M cells.

In this step, the control channels include the BCCH and the MCCH, where the BCCH is used by the NodeB to broadcast public information to all the UEs. The system information blocks of the public information includes cell selection and reselection parameters: one-to-one offset between cells and cell individual offset. The information broadcasted in the MCCH includes MBMS-related control messages and the offset of the MBMS preferred frequency layer, which is a one-to-many offset between one frequency layer and other frequency layers.

The offsets of the cell in this step include: one-to-one offset between cells, individual offset of a cell, and offset of the MBMS preferred frequency layer.

In this step, the process of obtaining the offsets of the cell includes: for a cell that is added in step 504, decoding the offsets in the information broadcasted in the MCCH and the BCCH; for a cell that already exists in the cell set, judging whether a value tag that is used to indicate whether the offsets are changed in the information broadcasted in the MCCH and the BCCH of the cell indicates that the offsets are changed; if the value tag indicates that the offsets are changed, decoding the offsets in the information broadcasted in the MCCH and the BCCH, and obtaining the offsets of the cell; otherwise, using the read offsets of the cell, without decoding the offsets in the broadcasted information.

Step 508: The UE sorts the cells in the cell set by sequence rule according to the signal levels and offsets of the cells in the cell set, and uses the top cell as the reselected cell or the cell for handover or repositioning.

In a fifth embodiment of the present invention, the network-side pre-configures the UE to measure a maximum of N cells and to read a maximum of M cells. Then, the UE scans N frequency points, identifies N cells by reading the pilots and synchronization channels of cells where the N frequency points are located, and uses these N cells as the initial cell set. The UE may also predetermine a threshold. The UE adds a cell corresponding to the frequency point to the cell set only when the signal level of the frequency point is higher than the threshold so as to establish the initial cell set.

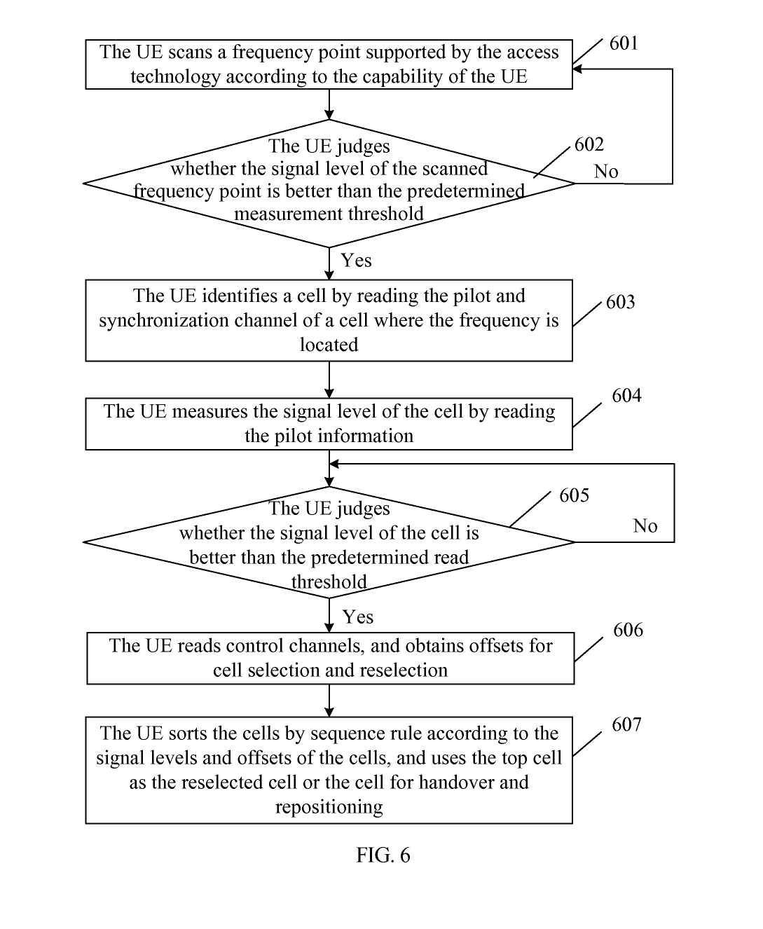

FIG. 6 is a flowchart of a method for measuring cells and reading control channels in a sixth embodiment of the present invention. The method includes:

Step 601: The UE scans all frequency points supported by the access technology according to the capability of the UE.

Step 602: The UE judges whether the signal levels of the scanned frequency points are higher than the pre-configured measurement threshold. If the signal levels of the scanned frequency points are higher than the pre-configured measurement threshold, the process proceeds to step 603; otherwise, the process goes back to step 601.

In this step, when the signal level is represented by the signal strength, the UE judges whether the signal strength of the scanned frequency points is greater than the pre-configured first signal strength threshold; if the signal strength of the scanned frequency points is greater than the pre-configured first signal strength threshold, the process proceeds to step 603. When the signal level is represented by the signal quality, the UE judges whether the signal quality of the scanned frequency points is better than the pre-configured first signal quality threshold; if the signal quality of the scanned frequency points is better than the pre-configured first signal quality threshold, the process proceeds to step 603. When the signal level is represented by the interference strength, the UE judges whether the interference strength of the scanned frequency points is less than the pre-configured first interference strength threshold; if the interference strength of the scanned frequency points is less than the pre-configured first interference strength threshold, the process proceeds to step 603.

Step 603: The UE identifies cells by reading the pilots and synchronization channels of cells where the frequency is located.

Step 604: The UE measures the signal levels of the cells by reading the pilot information.

Step 605: The UE judges whether the signal levels of the cells in the preceding step are higher than the pre-configured read threshold. If the signal levels of the cells in the preceding step are higher than the pre-configured read threshold, the process proceeds to step 606; otherwise, the process proceeds to step 605 again.

In this step, the UE judges whether the signal levels of the cells in the preceding step are higher than the pre-configured read threshold in the following modes: when the signal level is represented by the signal strength, the UE judges whether the signal strength of the cells is greater than the pre-configured second signal strength threshold; when the signal level is represented by the signal quality, the UE judges whether the signal quality of the cells is better than the pre-configured second signal quality threshold; when the signal level is represented by the interference strength, the UE judges whether the interference strength of the cells is less than the pre-configured second interference strength threshold.

Step 606: The UE reads control channels and obtains offsets for cell selection and reselection.

In this step, the control channels include the BCCH and the MCCH. The BCCH is used by the NodeB to broadcast public information to all the UEs, where the public information includes offsets for cell selection and reselection: one-to-one offset between cells and cell individual offset. The information broadcasted in the MCCH includes the offset of the MBMS preferred frequency layer, which is a one-to-many offset between one frequency layer and other frequency layers. The offsets of the cells in this step include: one-to-one offset between cells, cell individual offset, and offset of the MBMS preferred frequency layer.

Step 607: The UE sorts the cells by sequence rule according to the signal levels and offsets of the cells, and uses the top cell as the reselected cell or the cell for handover and repositioning.

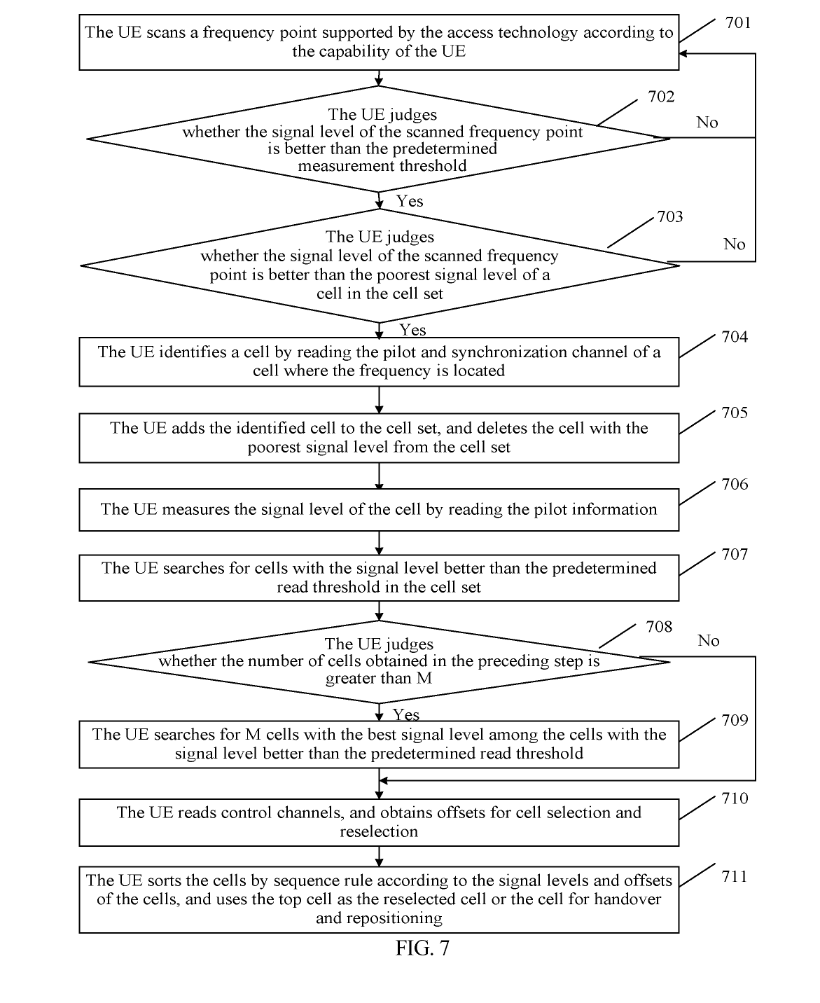

FIG. 7 is a flowchart of a method for measuring cells and reading control channels in a seventh embodiment of the present invention. The method includes:

Step 701: The UE scans a frequency point supported by the access technology according to the capability of the UE.

Step 702: The UE judges whether the signal level of the scanned frequency point is higher than the pre-configured measurement threshold. If the signal level of the scanned frequency point is higher than the pre-configured measurement threshold, the process proceeds to step 703; otherwise, the process goes back to step 701.

In this step, when the signal level is represented by the signal strength, the UE judges whether the signal strength of the scanned frequency point is greater than the pre-configured first signal strength threshold; if the signal strength of the scanned frequency point is greater than the pre-configured first signal strength threshold, the process proceeds to step 703. When the signal level is represented by the signal quality, the UE judges whether the signal quality of the scanned frequency points is better than the pre-configured first signal quality threshold; if the signal quality of the scanned frequency points is better than the pre-configured first signal quality threshold, the process proceeds to step 703. When the signal level is represented by the interference strength, the UE judges whether the interference strength of the scanned frequency point is less than the pre-configured first interference strength threshold; if the interference strength of the scanned frequency point is less than the pre-configured first interference strength threshold, the process proceeds to step 703.

Step 703: The UE judges whether the signal level of the scanned frequency point is higher than the poorest signal level of a cell in the cell set. If the signal level of the scanned frequency point is higher than the poorest signal level of the cell in the cell set, the process proceeds to step 704; otherwise, the process goes back to step 701.

In this step, when the signal strength of the scanned frequency point is greater than the littlest signal strength of a cell in the cell set, the process proceeds to step 704; or when the signal quality of the scanned frequency point is better than the poorest signal quality of a cell in the cell set, the process proceeds to step 704; or when the interference strength of the scanned frequency point is less than the littlest interference strength of a cell in the cell set, the process proceeds to step 704.

Step 704: The UE identifies a cell by reading the pilot and synchronization channel of a cell where the frequency is located.

Step 705: The UE adds the identified cell in the preceding step to the cell set, and deletes the cell with the poorest signal level from the cell set.

Step 706: The UE measures the signal level of the cell by reading the pilot information.

Step 707: The UE searches for cells with the signal level higher than the pre-configured read threshold in the cell set.

In this step, the UE searches for cells with the signal level higher than the pre-configured read threshold in the cell set in the following modes: when the signal level is represented by the signal strength, the UE searches for cells with the signal strength greater than the pre-configured second signal strength threshold; when the signal level is represented by the signal quality, the UE searches for cells with the signal quality better than the pre-configured second signal quality threshold; when the signal level is represented by the interference strength, the UE searches for cells with the interference strength less than the pre-configured second interference strength threshold.

Step 708: The UE judges whether the number of cells with the signal level higher than the pre-configured read threshold is greater than M. If the number of cells with the signal level higher than the pre-configured read threshold is greater than M, the process proceeds to step 709; otherwise, the process goes to step 710.

Step 709: The UE searches for M cells with the best signal level in the cells with the signal level higher than the pre-configured read threshold.

Step 710: The UE reads control channels and obtains offsets for cell selection and reselection.

In this step, the control channels include the BCCH and the MCCH. The BCCH is used by the NodeB to broadcast public information to all the UEs, where the public information includes cell selection and reselection parameters: one-to-one offset between cells and cell individual offset. The information broadcasted in the MCCH includes the offset of the MBMS preferred frequency layer, which is a one-to-many offset between one frequency layer and other frequency layers.

The offsets of the cell in this step include: one-to-one offset between cells, cell individual offset, and offset of the MBMS preferred frequency layer.

In this step, the process of obtaining the offsets of the cells includes: for a cell that is added in step 705, decoding the offsets in the information broadcasted in the MCCH and the BCCH; for a cell that already exists in the cell set, judging whether a value tag that is used to indicate whether the offsets are changed in the information broadcasted in the MCCH and the BCCH of the cell indicates that the offsets are changed; if the valued tag indicates that the offsets are changed, decoding the offsets in the information broadcasted in the MCCH and the BCCH, and obtaining the offsets of the cell; otherwise, using the read offsets of the cell, without decoding the offsets in the broadcasted information.

Step 711: The UE sorts the cells by sequence rule according to the signal levels and offsets of the cells, and uses the top cell as the reselected cell or the cell for handover and repositioning.

In a seventh embodiment of the present invention, the network pre-configures the UE to measure a maximum of N cells and to read a maximum of M cells; the UE scans N frequency points, identifies N cells by reading the pilots and synchronization channels of cells where the N frequency points are located, and uses these N cells as the initial cell set. The UE may also predetermine a threshold. The UE adds a cell corresponding to the frequency point to the cell set only when the signal level of the frequency point is higher than the threshold so as to establish the initial cell set.

In the preceding fifth embodiment to the seventh embodiment, the UE judges whether the signal level of a scanned frequency point meets the pre-configured measurement condition; the UE measures the signal level of a cell corresponding to the frequency point only when the signal level of the scanned frequency point meets the pre-configured measurement condition. Thus, the number of cells measured by the UE is limited. In addition, the UE judges whether the signal level of a measured cell meets the pre-configured read condition; the UE reads control channels only when the signal level of the cell meets the read condition. Thus, the number of cells read by the UE is limited; the time needed by the UE to read the control channels is reduced; and the cell reselection time is decreased.

For better understanding of the eighth embodiment and the ninth embodiment of the present invention, the following describes the reuse of physical scrambles.

In a scenario where a macro cell and a micro cell (a home NodeB or a closed subscriber group (CSG) cell) overlap, the physical scrambles may be reused due to a large number of micro cells. For example, if a macro cell (the current serving cell of the UE) is a neighbor cell of more than 1,000 micro cells, more than 1,000 physical scrambles are needed to identify the neighbor cells of the UE theoretically. However, there are only 512 physical scrambles in a wideband code division multiple access (WCDMA) system and 504 physical scrambles in a long time evolution (LTE) system. As a result, the physical scrambles are reused; that is, one physical scramble may be used to identify multiple cells. Thus, the physical scrambles cannot be used to identify the neighbor cells one by one. Because the number of macro cells around a macro cell (the current serving cell of the UE) is always limited, the physical scrambles are reused due to a large number of micro cells.

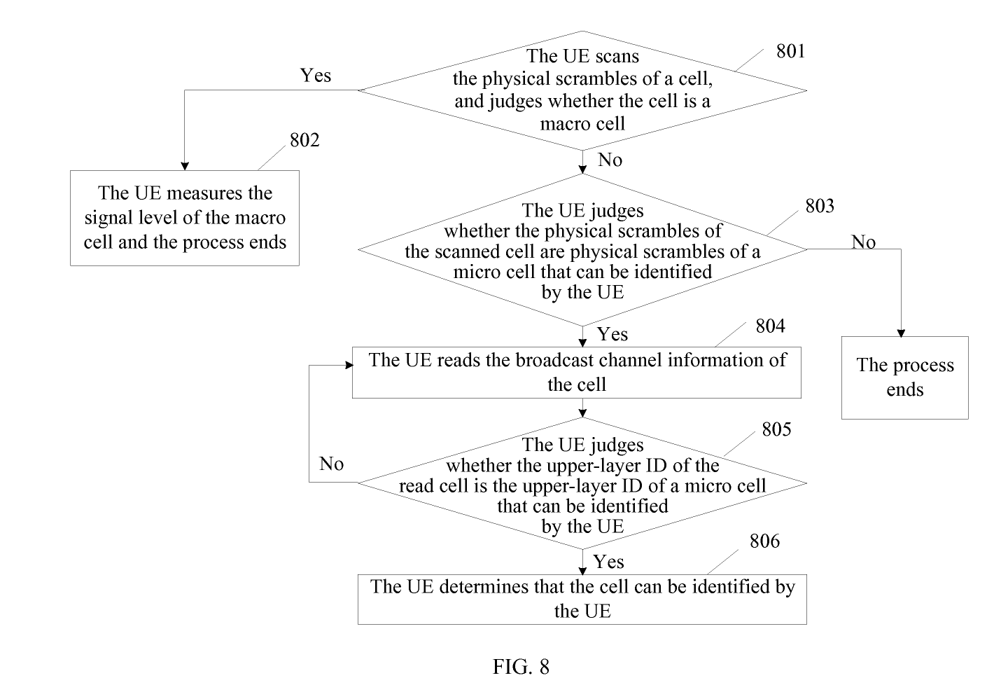

FIG. 8 is a flowchart of a method for reading control channels in an eighth embodiment of the present invention. Prior to this method, special physical scrambles of a macro cell are pre-configured or a list of physical scrambles of a micro cell that can be identified by the UE is pre-configured. In this embodiment of the present invention, the UE judges whether scanned physical scrambles are the special physical scrambles of the macro cell or the physical scrambles of a micro cell that can be identified by the UE; if scanned physical scrambles are the special physical scrambles of the macro cell or the physical scrambles of a micro cell that can be identified by the UE, the UE reads control channels corresponding to the cell. Thus, the number of control channels read by the UE is limited. The method includes:

Step 801: The UE scans physical scrambles of a cell, and judges whether the cell is a macro cell according to the scanned physical scrambles. If the cell is the macro cell according to the scanned physical scrambles, the process proceeds to step 802; otherwise, the process goes to step 803.

Prior to this step, special physical scrambles are pre-configured to identify the macro cell, so that the macro cell can be uniquely identified by the physical scrambles. For example, the number of macro cells acting as the neighbor cells may be pre-configured as 8, 16, or 32. In this embodiment, supposing the number of macro cells acting as the neighbor cells is pre-configured as 8, eight physical scrambles may be used to identify the macro cell. The network and the UE may make an appointment that eight special physical scrambles are used by the macro cell and other physical scrambles are used by the micro cell. In this step, the UE scans physical scrambles of a cell; the UE determines that the cell is a macro cell if finding that the scanned physical scrambles of the cell are special physical scrambles reserved for the macro cell; otherwise, the UE determines that the cell is a micro cell.

Step 802: The UE measures the signal level of the macro cell. Then, the process ends.

Step 803: The UE judges whether the scanned physical scrambles of the cell are physical scrambles of a micro cell that can be identified by the UE. If the scanned physical scrambles of the cell are physical scrambles of the micro cell that can be identified by the UE, the process proceeds to step 804; otherwise, the process ends.

Prior to this step, the UE pre-configures a cell support list that includes physical scrambles of a micro cell that can be identified by the UE and the upper-layer ID of the micro cell.

In this step, the UE judges whether the scanned physical scrambles of the cell are physical scrambles of a micro cell that can be identified by the UE in the following mode: judging whether the scanned physical scrambles of the cell are physical scrambles in the cell support list.

Step 804: The UE reads broadcast channel information of the cell, where the read information includes the upper-layer ID of the cell.

Step 805: The UE judges whether the read upper-layer ID of the cell is the upper-layer ID of a micro cell that can be identified by the UE. If the read upper-layer ID of the cell is not the upper-layer ID of a micro cell that can be identified by the UE, the process goes back to step 804; otherwise, the process proceeds to step 806.

Because the physical scrambles are reused, the UE judges whether the cell is supported by the UE by judging whether the read upper-layer ID of the cell is the upper-layer ID of a micro cell that can be identified by the UE. The step of judging whether the read upper-layer ID of the cell is the upper-layer ID of a micro cell that can be identified by the UE may include: judging whether the read upper-layer ID of the cell is the upper-layer ID of a micro cell in the cell list.

Step 806: The UE determines that the cell can be identified by the UE, configures the measurement offsets of the cell, and uses the measurement result or reports the measurement result.

The step of configuring the measurement offsets includes: adding the signal level of the cell to the offsets of neighbor cells configured by the current serving cell, and obtaining the measurement offsets of the cell.

In the eighth embodiment of the present invention, the UE judges whether the physical scrambles of a cell are physical scrambles of a cell that can be identified by the UE. The UE reads control channels only when the physical scrambles of the cell are physical scrambles of the cell that can be identified by the UE. Thus, the number of cells read by the UE is limited; the time needed by the UE to read control channels of the cell is reduced; and the mobility processing time of the UE is saved. In addition, the UE reads only control channels of cells that meet the pre-configured read condition, where these cells have high signal levels, so that the decoding error rate is reduced when the UE reads the control channels to obtain the parameters of the cells.

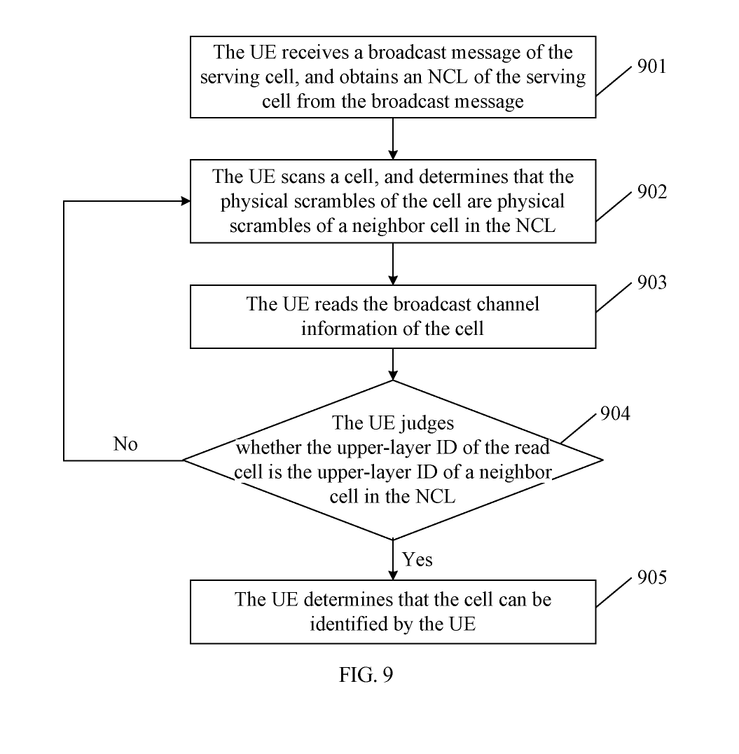

FIG. 9 is a flowchart of a method for identifying cells. In this method, the broadcasted NCL in the cell in the method includes both physical scrambles and IDs of neighbor cells. The method includes:

Step 901: The UE receives a broadcast message of the serving cell, and obtains an NCL of the serving cell from the broadcast message, where the NCL includes physical scrambles and upper-layer IDs of the neighbor cells.

Step 902: The UE scans a cell, and determines that the physical scrambles of the cell are physical scrambles of neighbor cells in the NCL.

Step 903: The UE measures the signal level of the cell, and reads the broadcast channel information of the cell, where the read information includes the upper-layer ID of the cell.

Step 904: The UE judges whether the read upper-layer ID of the cell is the upper-layer ID of a neighbor cell in the NCL. If the read upper-layer ID of the cell is not the upper-layer ID of a neighbor cell in the NCL, the process goes back to step 902; otherwise, the process proceeds to step 905.

Step 905: The UE determines that the cell can be identified by the UE, configures the measurement offsets of the cell, and uses the measurement result or reports the measurement result.

The step of configuring the measurement offsets includes: adding the signal level of the cell to the offsets of neighbor cells configured by the current serving cell, and obtaining the measurement offset of the cell.

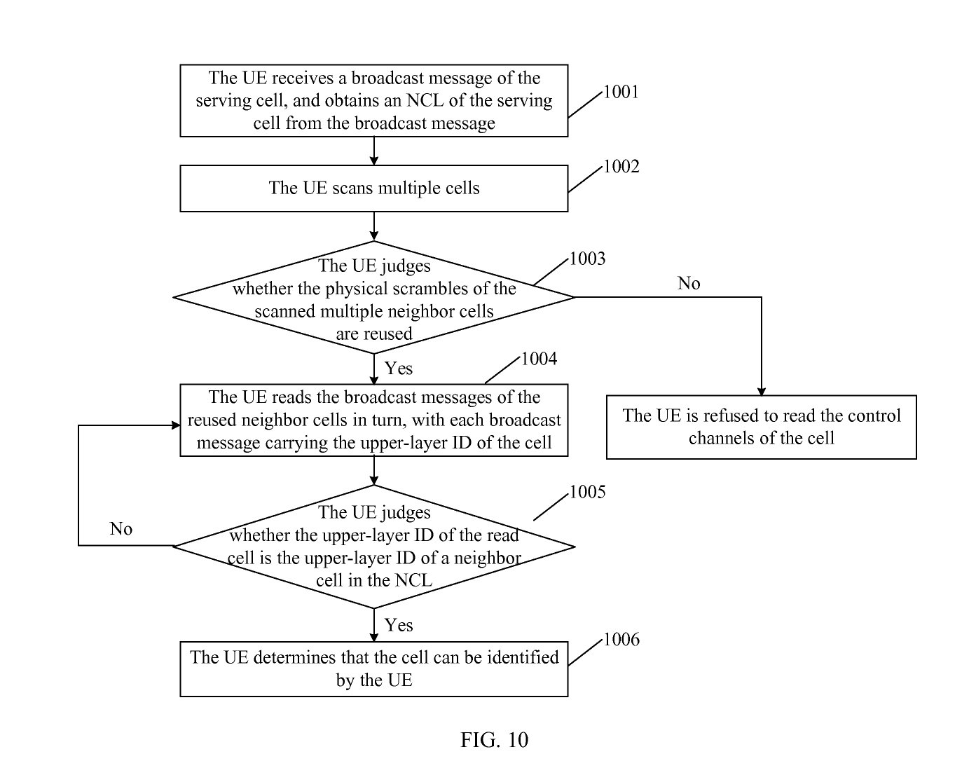

FIG. 10 is a flowchart of a method for identifying cells. In this method, the broadcasted NCL in the cell includes physical scrambles and upper-layer IDs of neighbor cells. The method includes:

Step 1001: The UE receives a broadcast message of the serving cell, and obtains an NCL of the serving cell from the broadcast message, where the NCL includes physical scrambles and upper-layer IDs of the neighbor cells.

Step 1002: The UE scans multiple neighbor cells.

Step 1003: The UE judges whether the physical scrambles of the scanned neighbor cells are reused. If the physical scrambles of the scanned neighbor cells are reused, the process proceeds to step 1004; otherwise, the UE refuses to read the control channels of the cell.

The step of judging whether the physical scrambles of the scanned neighbor cells are reused is to judge whether the cell is uniquely identified by the physical scrambles of the scanned cell. If the physical scrambles of the scanned neighbor cells are not reused, the cell can be uniquely identified by the physical scrambles; otherwise, the cell cannot be uniquely identified by the physical scrambles.

Step 1004: The UE reads broadcast messages of the reused neighbor cells in turn, where the broadcast messages carry the upper-layer ID of the cell.

Step 1005: The UE judges whether the read upper-layer ID of the cell is the upper-layer ID of a neighbor cell in the NCL. If the read upper-layer ID of the cell is not the upper-layer ID of a neighbor cell in the NCL, the process goes back to step 1004; otherwise, the process proceeds to step 1006.

Step 1006: The UE determines that the cell is supported by the UE, configures the measurement offsets of the cell, and uses the measurement result or reports the measurement result.

In a ninth embodiment and a tenth embodiment of the present invention, the UE obtains an NCL from the current serving cell, and judges whether the upper-layer ID of the cell read from the control channels is the upper-layer ID in the NCL; the UE determines that the cell can be identified by the UE only when the judgment result of the UE is positive. Thus, it is guaranteed that the UE can identify a correct cell.

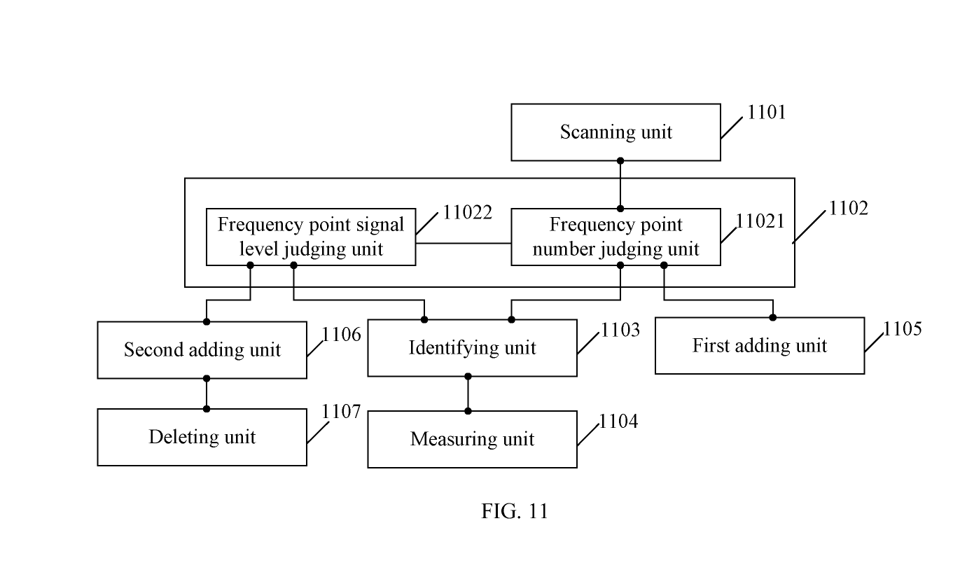

FIG. 11 illustrates a UE in an eleventh embodiment of the present invention. The UE includes:

a scanning unit 1101, adapted to scan a frequency point;

a frequency point judging unit 1102, adapted to judge whether the scanned frequency point meets a pre-configured measurement condition;

an identifying unit 1103, adapted to identify a cell corresponding to the frequency point when the judgment result of the frequency point judging unit 1102 is positive; and

a measuring unit 1104, adapted to measure the signal level of the identified cell.

Specifically, the frequency point judging unit 1102 is adapted to: judge whether the signal strength of the scanned frequency point is greater than the pre-configured signal strength threshold when the signal level of the scanned frequency point is represented by the signal strength; judge whether the signal quality of the scanned frequency point is better than the pre-configured signal quality threshold when the signal level of the scanned frequency point is represented by the signal quality; and judge whether the interference strength of the scanned frequency point is less than the pre-configured interference strength threshold when the signal level of the scanned frequency point is represented by the interference strength.

Specifically, the frequency point judging unit 1102 includes a frequency point number judging unit 11021 and a frequency point signal level judging unit 11022.

The frequency point number judging unit 11021 is adapted to judge whether the scanned frequency point is within the pre-configured number of frequency points.

The frequency point signal level judging unit 11022 is adapted to judge whether the signal level of the scanned frequency point is higher than the lowest signal level of a cell in the cell set with a pre-configured number of cells when the judgment result of the frequency point number judging unit 11021 is positive.

The identifying unit 1103 is adapted to identify a cell corresponding to the frequency point when the judgment result of the frequency point number judging unit 11021 is positive or when the judgment result of the frequency point signal level judging unit 11022 is positive.

The UE further includes:

a first adding unit 1105, adapted to add a cell to the cell set when the judgment result of the frequency point number judging unit 11021 is positive;

a second adding unit 1106, adapted to add the identified cell to the cell set when the judgment result of the frequency point signal level judging unit 11022 is positive; and

a deleting unit 1107, adapted to delete a cell with the poorest signal level from the cell set.

In this embodiment of the present invention, the frequency point judging unit 1102 judges whether the signal level of the scanned frequency point meets the pre-configured measurement condition; the measuring unit 1104 measures the signal level of a cell corresponding to the frequency point only when the signal level of the scanned frequency point meets the pre-configured measurement condition. Thus, the number of cells measured by the UE is limited, which prevents the UE from measuring too many cells.

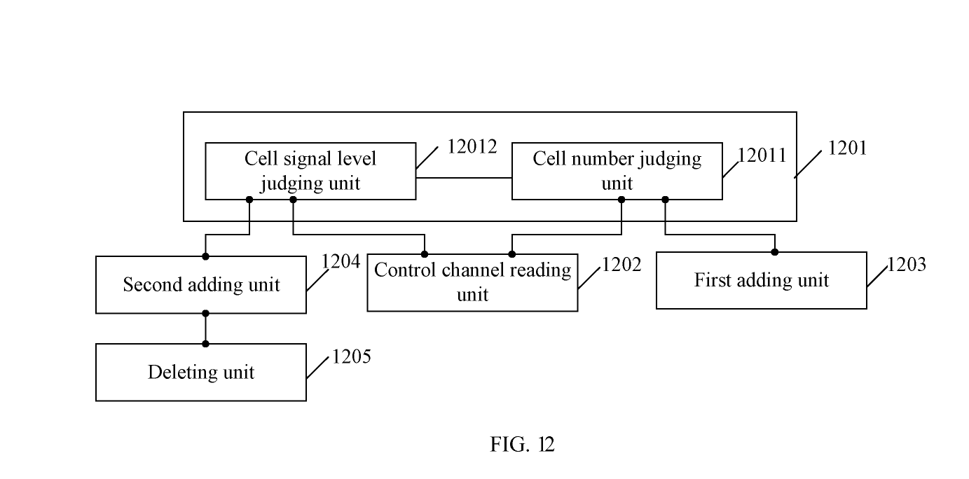

FIG. 12 illustrates a UE in a twelfth embodiment of the present invention. The UE includes:

a cell judging unit 1201, adapted to judge whether a cell meets the pre-configured read condition; and

a control channel reading unit 1202, adapted to read the control channel information of the cell when the judgment result of the cell judging unit 1201 is positive.

Specifically, the cell judging unit 1201 is adapted to: judge whether the signal strength of the cell is greater than the pre-configured signal strength threshold when the signal level of the cell is represented by the signal strength; judge whether the signal quality of the cell is better than the pre-configured signal quality threshold when the signal level of the cell is represented by the signal quality; and judge whether the interference strength of the cell is less than the pre-configured interference strength threshold when the signal level of the cell is represented by the interference strength.

Specifically, the cell judging unit 1201 includes a cell number judging unit 12011 and a cell signal level judging unit 12012.

The cell number judging unit 12011 is adapted to judge whether the cell is within the pre-configured number of cells.

The cell signal level judging unit 12012 is adapted to judge whether the signal level of the cell is higher than the poorest signal level of a cell in the cell set with the pre-configured number of cells when the judgment result of the cell number judging unit 12011 is negative.

The control channel reading unit 1202 is adapted to read control channels of the cell to obtain cell related parameters when the judgment result of the cell number judging unit 12011 is positive or when the judgment result of the cell signal level judging unit 12012 is positive.

The UE further includes:

a first adding unit 1203, adapted to add a cell to the cell set when the judgment result of the cell number judging unit 12011 is positive;

a second adding unit 1204, adapted to add the identified cell to the cell set when the judgment result of the cell signal level judging unit 12012 is positive; and

a deleting unit 1205, adapted to delete a cell with the poorest signal level from the cell set.

In this embodiment, the cell judging unit 1201 judges whether the signal level of the cell is higher than the pre-configured read threshold; the control channel reading unit 1202 reads control channels only when the signal level of the cell is higher than the pre-configured read threshold. Thus, the number of cells read by the UE is limited; the time needed by the UE to read the control channels of the cell is reduced; and the mobility processing time of the UE is saved. In addition, the UE reads only control channels of cells that meet the pre-configured read condition, where these cells have high signal levels, so that the decoding error rate is reduced when the UE reads the control channels to obtain the parameters of the cells.

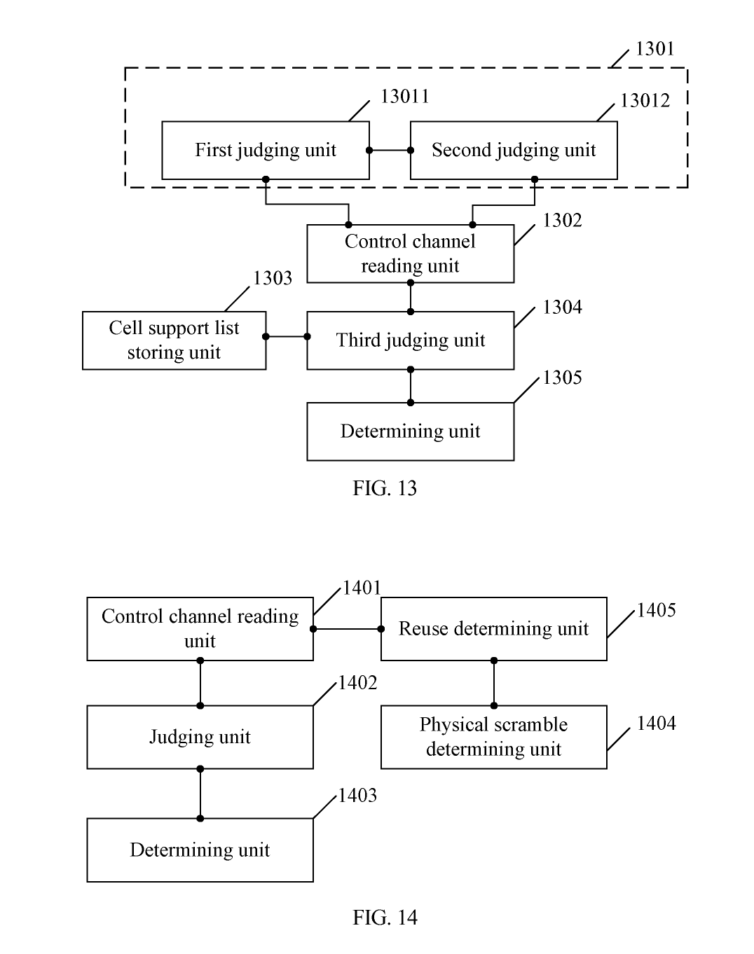

FIG. 13 illustrates a UE in a thirteenth embodiment of the present invention. The UE includes:

a cell judging unit 1301, adapted to judge whether a cell meets the pre-configured read condition; and

a control channel reading unit 1302, adapted to read the control channel information of the cell when the judgment result of the cell judging unit 1301 is positive.

The cell judging unit 1301 includes:

a first judging unit 13011, adapted to judge whether the physical scrambles of the cell are pre-configured physical scrambles of a macro cell; and

a second judging unit 13012, adapted to judge whether the physical scrambles of the cell are physical scrambles of a micro cell that can be identified by the UE when the judgment result of the first judging unit 13011 is negative.

The control channel reading unit 1302 is adapted to read the control channel information of the cell when the judgment result of the first judging unit 13011 is positive or when the judgment result of the second judging unit 13012 is positive.

The UE further includes:

a cell support list storing unit 1303, adapted to store a cell support list that includes physical scrambles and the upper-layer ID of a micro cell that can be identified by the UE;

a third judging unit 1304, adapted to judge whether the upper-layer ID in the read control channel information is the upper-layer ID of a micro cell that can be identified by the UE; and

a determining unit 1305, adapted to determine that the cell can be identified by the UE when the judgment result of the third judging unit 1304 is positive.

In this embodiment of the present invention, the cell judging unit 1301 judges whether the physical scrambles of a cell are physical scrambles of a cell that can be identified by the UE; the control channel reading unit 1302 reads the control channel information of the cell only when the judgment result of the cell judging unit 1301 is positive. Thus, the number of cells read by the UE is limited; the time needed by the UE to read the control channels of the cell is reduced; and the mobility processing time of the UE is saved. In addition, the UE reads only the control channels of cells that meet the pre-configured read condition, where these cells have high signal levels, so that the decoding error rate is reduced when the UE reads the control channels to obtain parameters of the cells.

FIG. 14 illustrates a UE in a fourteenth embodiment of the present invention. The UE includes:

a control channel reading unit 1401, adapted to read control channel information of a cell, where the read information includes the upper-layer ID of the cell;

a judging unit 1402, adapted to judge whether the read upper-layer ID of the cell is the upper-layer ID in an NCL, which is obtained from the serving cell of the UE; and

a determining unit 1403, adapted to determine that the cell can be identified by the UE when the judgment result of the judging unit 1402 is positive.

The UE further includes:

a physical scramble determining unit 1404, adapted to: scan a cell, and determine that the physical scrambles of the scanned cell are physical scrambles in the NCL.

The control channel reading unit 1401 reads the control channel information of the cell after the physical scramble determining unit 1404 determines that the physical scrambles of the scanned cell are physical scrambles in the NCL.

When more than two cells are scanned, the UE further includes:

a reuse determining unit 1405, adapted to judge whether the cell is uniquely identified by the physical scrambles of the scanned cell after the physical scramble determining unit 1404 determines that the physical scrambles of the scanned cell are physical scrambles in the NCL.

The control channel reading unit 1401 reads control channel information of the cell when the physical scramble determining unit 1404 determines that the physical scrambles of the scanned cell are physical scrambles in the NCL and when the reuse determining unit determines that the cell cannot be uniquely identified by the physical scrambles of the scanned cell.

In this embodiment of the present invention, the judging unit 1402 judges whether the upper-layer ID of the cell read from the control channels is the upper-layer ID in the NCL; the determining unit 1403 determines that the cell can be identified by the UE when the judgment result of the judging unit 1402 is positive. Thus, it is guaranteed that the UE can identify a correct cell.

It is understandable to those skilled in the art that all or part of the steps of the foregoing embodiments may be implemented by hardware instructed by a program. The program may be stored in a computer-readable storage medium. When being executed, the program performs one or any combination of the steps of the foregoing embodiments.

In addition, each function unit in embodiments of the present invention may be integrated into a processing module, or exists physically, or two or more units are integrated into a module. The integrated module may be implemented in the form of hardware or software function unit. If the integrated module is implemented in the form of software function unit and is sold or used as an independent product, the integrated module may also be stored in a computer readable storage medium.

The storage medium may be a read-only memory (ROM), a magnetic disk or a compact disk (CD).

Detailed above are a method and UE for measuring cells and reading control channels. It is apparent that those skilled in the art can make various modifications and variations to the embodiments and the application scope of the invention without departing from the principle and scope of the invention. Thus, the specifications shall not be construed as a limitation to the invention.

What is claimed is:

1. A method for reading control channels, comprising:
judging whether a cell meets a pre-configured read condition; and
reading control channel information of the cell if the cell meets the pre-configured read condition.

2. The method of claim 1, wherein judging whether a cell meets a pre-configured read condition comprises:
judging whether physical scrambles of the cell are physical scrambles of a cell that can be identified by a UE;
wherein if physical scrambles of the cell are physical scrambles of a cell that can be identified, the cell meets a pre-configured read condition.

3. The method of claim 2, wherein judging whether physical scrambles of the cell are physical scrambles of a cell that can be identified by the UE comprises:
judging whether physical scrambles of the cell are pre-configured physical scrambles of a macro cell;
wherein, if physical scrambles of the cell are pre-configured physical scrambles of a macro cell, the cell meets a pre-configured read condition; or
judging whether physical scrambles of the cell are physical scrambles of a micro cell that can be identified by the UE if physical scrambles of the cell are not pre-configured physical scrambles of a macro cell; wherein if physical scrambles of the cell are physical scrambles of the micro cell that can be identified by the UE, the cell meets a pre-configured read condition.

4. The method of claim 3, wherein judging whether physical scrambles of the cell are physical scrambles of a micro cell that can be identified by the UE comprises:
judging whether physical scrambles of the cell are physical scrambles in the pre-stored cell support list, wherein the cell support list comprises physical scrambles of a micro cell that can be identified by the UE.

5. The method of claim 4, wherein
the cell support list further comprises an upper-layer ID of a micro cell that can be identified by the UE; and
when physical scrambles of the cell are physical scrambles of a micro cell that can be identified by the UE, after reading control channel information of the cell, the method further comprises:
judging whether an upper-layer ID in the read control channel information is an upper-layer ID that can be identified by the UE; and
determining the cell is a micro cell that can be identified by the UE if the upper-layer ID in read channel information is the upper-layer ID that can be identified by the UE.

6. The method of claim 1, wherein the read control channel information of the cell comprises a value tag that is used for indicating whether offsets of the cell are changed; and
after reading control channel information of the cell, the method further comprises:
judging, according to the tag, whether the offsets are changed; and obtaining offsets from the control channel if the offsets are changed; or
using the previously read offsets of the cell as the offsets if the offsets are not changed.

7. A method for identifying cells, comprising:
reading, by an UE, control channel information of a cell including an upper-layer ID; and
judging whether the read upper-layer ID of the cell is the upper-layer ID of a neighbor cell in a neighbor cell list (NCL); and determining the cell is a micro cell that can be identified by the UE if the read upper-layer ID of the cell is the upper-layer ID of a neighbor cell in the NCL, wherein the NCL is obtained from the current serving cell of the UE.

8. The method of claim 7, wherein before reading, by an UE, control channel information, the method further comprises:
scanning cells by the UE; and
determining, by the UE, physical scrambles of cell that is scanned by the UE are physical scrambles in the NCL.

9. The method of claim 8, wherein when more than two cells are scanned, after determining that physical scrambles of cell scanned by the UE are physical scrambles in the NCL and before reading control channel information of the cell, the method further comprises:
determining whether the cell is uniquely identified by the physical scrambles of the scanned cell, wherein: if the cell is uniquely identified by the physical scrambles of the scanned cell, the control channel information of the cell is not read; if the cell is not uniquely identified by the physical scrambles of the scanned cell, it is again judged whether the physical scrambles of the scanned cell are physical scrambles in the NCL.

10. An UE, characterized by comprising:
a cell judging unit, adapted to judge whether a cell meets the pre-configured read condition; and
a control channel reading unit, adapted to read the control channel information of the cell when the cell meets the pre-configured read condition.

11. The UE of claim 10, wherein the cell judging unit comprises:
a first judging unit, adapted to judge whether the physical scrambles of the cell are pre-configured physical scrambles of a macro cell; and
a second judging unit, adapted to judge whether the physical scrambles of the cell are physical scrambles of a micro cell that can be identified by the UE when the physical scrambles of the cell are not pre-configured physical scrambles of a macro cell.
